(19) United States
(12) Patent Application Publication
(10) Pub. No.: US 2015/0170392 A1
(43) Pub. Date: Jun. 18, 2015

(54) ELECTRONIC DEVICE AND METHOD FOR OUTPUTTING HANDWRITING FONTS

(71) Applicants: SHENZHEN FUTAIHONG PRECISION INDUSTRY CO., LTD., Shenzhen (CN); CHIUN MAI COMMUNICATION SYSTEMS, INC., New Taipei (TW)

(72) Inventor: YAO-YU YANG, Shenzhen (CN)

(21) Appl. No.: 14/566,918

(22) Filed: Dec. 11, 2014

(30) Foreign Application Priority Data
Dec. 18, 2013 (CN) 201310697931.7

(51) Int. Cl. G06T 11/60; G06T 11/20; G06F 3/041

(52) U.S. Cl. CPC G06T 11/60; G06F 3/0416; G06T 11/20

(57) ABSTRACT

In a method for an electronic device to output handwriting fonts, a thickness and a color is chosen for lines of handwriting fonts. Coordinates of touch points in response to a handwriting operation on the touch screen are recorded and one or more handwriting fonts are generated based on the recorded touch points. A first bitmap including the generated handwriting fonts is generated and a compression ratio between a minimum area of the generated handwriting fonts in the first bitmap and a area of a font in a text box of the electronic device is calculated. The generated handwriting fonts are compressed according to the compression ratio and a second bitmap including the compressed handwriting fonts is generated. The second bitmap is converted into a figure, and the figure is outputted in the text box of the electronic device.

### CROSS-REFERENCE TO RELATED APPLICATIONS

This application claims priority to Chinese Patent Application No. 201310697931.7 filed on Dec. 18, 2013, the contents of which are incorporated by reference herein.

### FIELD

The subject matter herein generally relates to input/output technology, and particularly to an electronic device and method for outputting handwriting fonts.

### BACKGROUND

An electronic device (e.g., a mobile phone or a computer) can provide a character input application that receives user typing operations, which can be used, for example, to input letters, words, numbers, symbols, and Chinese characters. The character input application can further provide a handwriting input function. However, the handwriting input function cannot output handwriting characters having same those shapes as those handwritten by a user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device including a handwriting fonts outputting system.

FIG. 2 is a flowchart of an example embodiment of a method for outputting handwriting fonts in the electronic device of FIG. 1.

FIG. 3 is a diagrammatic view of an example embodiment of a handwriting font output on the touch screen of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

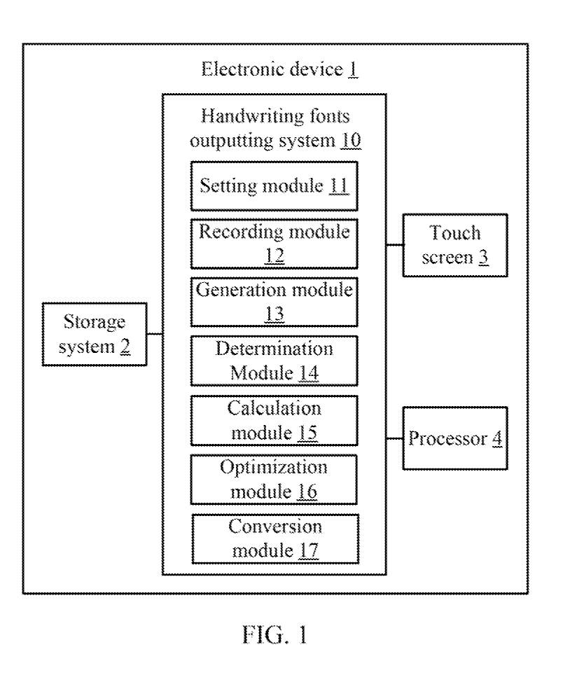

FIG. 1 illustrates a block diagram of an example embodiment of an electronic device including a handwriting fonts outputting system. In at least one embodiment, an electronic device 1 includes a handwriting fonts outputting system 10, the electronic device 1 can be a tablet computer, a personal digital assistant, a notebook computer, a mobile phone, or any other suitable electronic device. The electronic device 1 further includes, but is not limited to, a storage system 2, a touch screen 3, and at least one processor 4. The touch screen 3 can recognize touches of a finger of a user or a stylus on the touch screen 3. FIG. 1 illustrates only one example of the electronic device that can include more or fewer components than illustrated, or have a different configuration of the various components in other embodiments.

In at least one embodiment, the storage system 2 can include various types of non-transitory computer-readable storage media. For example, the storage system 2 can be an internal storage system, such as a flash memory, a random access memory (RAM) for temporary storage of information, and/or a read-only memory (ROM) for permanent storage of information. The storage system 2 can also be an external storage system, such as a hard disk, a storage card, or a data storage medium. The at least one processor 4 can be a central processing unit (CPU), a microprocessor, or other data processor chip that performs functions of the electronic device 1.

The handwriting fonts outputting system 10 can record touch points when a handwriting operation is applied to the touch screen 3, generate handwriting fonts based on the recorded touch points, and output a figure including the generated handwriting fonts by converting the generated handwriting fonts into a figure. In at least one embodiment, the handwriting fonts outputting system 10 can include a setting module 11, a recording module 12, a generation module 13, a determination module 14, a calculation module 15, a optimization module 16, and a conversion module 17. The function modules 11-17 can include computerized code in the form of one or more programs, which are stored in the storage system 2. The at least one processor 4 executes the computerized code to provide functions of the function modules 11-17.

The setting module 11 provides a user interface on the touch screen 3 of the electronic device 1, in which the user can choose different thicknesses and colors for lines of handwriting fonts. In at least one embodiment, the thicknesses of the lines of the handwriting fonts are, but are not limited to, 0-30 pt. The colors of the lines of the handwriting fonts include, but are not limited to, white, black, red, yellow, green, blue, or any other colors. In other embodiments, the thicknesses and colors of the lines of the handwriting fonts also can be user-defined.

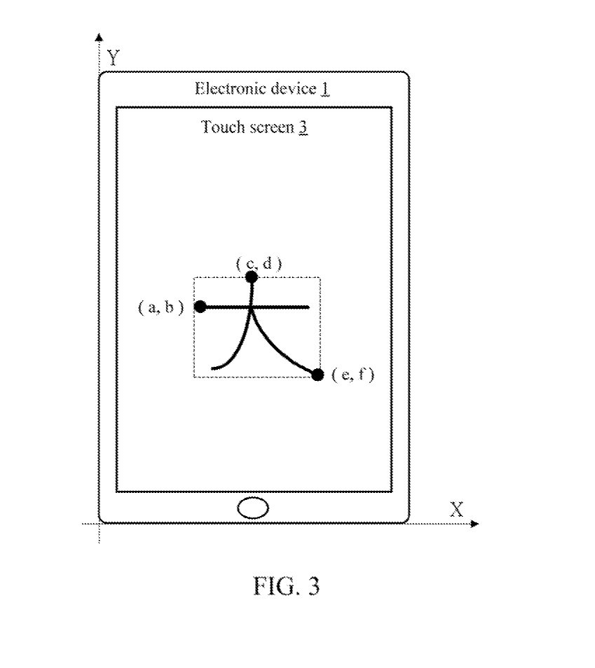

The recording module 12 records coordinates of touch points when a touch operation (e.g., a handwriting operation) is executed on the touch screen 3. In at least one embodiment, as an example as shown in FIG. 3, a coordinate system is established on the touch screen 3. When a touch operation is detected by the touch screen 3, a plurality of groups of touch events are generated in response to the touch operation. Each group of the touch events can include at least a touch_down event, a touch_move event and a touch_up event. Each group of the touch events represents a path of user handwriting forming fonts, moving from one touch point of the touch screen 3 to another touch point before releasing. A touch event of each group of the touch events includes one or more touch points. The recording module 12 records the coordinates of all the touch points by detecting the touch events when the touch operation is executed on the touch screen 3.

The generation module 13 generates one or more handwriting paths based on the coordinates of the recorded touch points, and generates one or more handwriting fonts based on the generated handwriting paths according to the chosen thickness and the chosen color. The generation module 13 further generates a first bitmap including the generated handwriting fonts. In at least one embodiment, each of the generated handwriting fonts is generated based on one or more non-matching paths.

The determination module 14 determines a minimum area of the generated handwriting fonts in the first bitmap and determines an area of a font in a text box of the electronic device 1.

In at least one embodiment, the determination module 14 firstly determines several points of the handwriting fonts which are generated based on the touch points, for example, a point having a maximum Y-coordinate value of the generated handwriting fonts, a point having a minimum Y-coordinate value of the generated handwriting fonts, a point having a maximum X-coordinate value of the generated handwriting fonts and a point having a minimum X-coordinate value of the generated handwriting fonts. According to the determined points above, the determination module 14 determines the minimum area of the generated handwriting fonts in the first bitmap by using a formula. For example, the formula can be denoted as “the minimum area=(the maximum Y-coordinate value−the minimum Y-coordinate value)*(the maximum X-coordinate value−the minimum X-coordinate value)”. As the example in FIG. 3 shows, if the generated handwriting fonts in the first bitmap is Chinese character “ [symbol] ”, and a point (c, d) of the generated handwriting fonts has the maximum Y-coordinate value, a point (e, f) of the generated handwriting fonts has the minimum Y-coordinate value, a point (e, f) of the generated handwriting fonts has the maximum X-coordinate value, a point (a, b) of the generated handwriting fonts has the minimum X-coordinate value. The formula of the minimum area of the generated handwriting fonts “ [symbol] ” can be denoted as “the minimum area=(e−a)*(d−f)”.

The area of the font in the text box represents a size of a font that is output in the text box, and thus the area of the font in the text box can be determined by character input software. So, the determination module 14 can determine the area of the font in the text box.

The calculation module 15 calculates a compression ratio between the minimum area of the generated handwriting fonts in the first bitmap and the area of the font in the text box of the electronic device 1. In at least one embodiment, the calculation module 15 calculates the compression ratio by using a formula. The formula can be denoted as “the compression ratio=(the minimum area of the generated handwriting fonts in the first bitmap)/(the area of the font in the text box of the electronic device 1)”.

The optimization module 16 compresses the generated handwriting fonts in the first bitmap according to the compression ratio and generates a second bitmap including the compressed handwriting fonts. The second bitmap has the same size as the font in the text box. In at least one embodiment, the optimization module 16 invokes a matrix function to compress the generated handwriting fonts in the first bitmap. For example, if the compression ratio is 100, and the coordinates of a point of the generated handwriting fonts in the first bitmap are (200, 300), after being compressed, updated coordinates of the point become (2, 3).

The conversion module 17 converts the second bitmap into a figure and output the figure in the text box of the electronic device 1. Thus, the handwriting fonts outputting system 10 can output handwriting fonts as written by a stylus or a finger of the user, but does not use standard fonts provided by the character input software to replace the handwriting fonts.

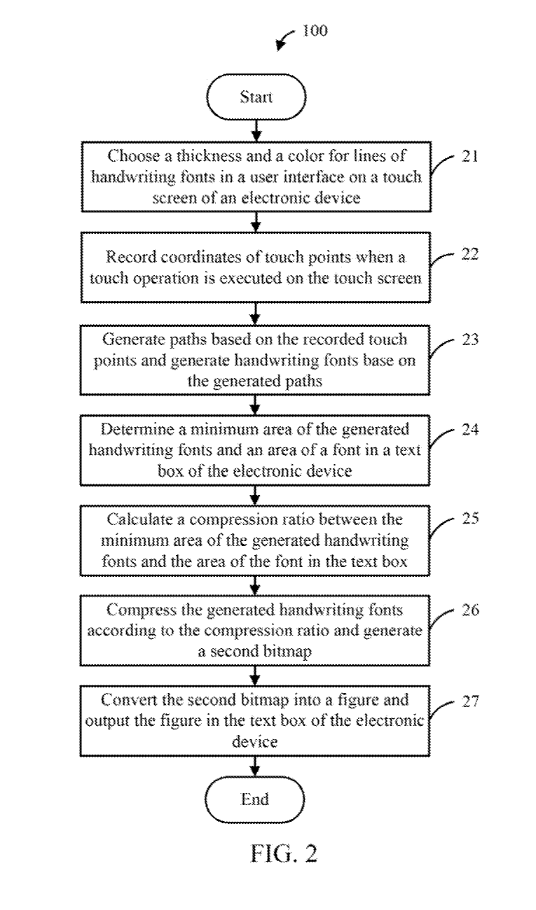

FIG. 2 illustrates a flowchart of an example embodiment of a method 100 for outputting handwriting fonts in the electronic device of FIG. 1. In at least one embodiment, the method 100 is provided by way of example, as there are a variety of ways to carry out the method. The method 100 described below can be carried out using the configurations illustrated in FIG. 1, for example, and various elements of these figures are referenced in explaining example method. Each block shown in FIG. 2 represents one or more processes, methods, or subroutines, carried out in the exemplary method. Furthermore, the illustrated order of blocks is by example only and the order of the blocks can be changed. The exemplary method can begin at block 21. Depending on the embodiment, additional blocks can be added, others removed, and the ordering of the blocks can be changed.

At block 21, a setting module provides a user interface on a touch screen of an electronic device, in which the user can choose different thicknesses and colors for lines of handwriting fonts. In at least one embodiment, the thicknesses of the lines of the handwriting fonts are, but are not limited to, 0-30 pt. The colors of the lines of the handwriting fonts include, but are not limited to, white, black, red, yellow, green, blue, or other colors. In another embodiment, the thicknesses and colors of the lines of the handwriting fonts also can be user-defined.

At block 22, a recording module records coordinates of touch points when a touch operation (e.g., a handwriting operation) is applied to the touch screen. In at least one embodiment, as the example in FIG. 3 shows, a coordinate system is established on the touch screen. When a touch operation is detected by the touch screen, a plurality of groups of touch events are generated in response to the touch operation. Each group of the touch events can include at least a touch_down event, a touch_move event and a touch_up event. Each group of the touch events represents a path of user handwriting forming fonts, moving from one touch point of the touch screen 3 to another touch point before releasing. A touch event of each group of the touch events includes one or more touch points. The recording module records the coordinates of all the touch points by detecting the touch events when the touch operation is applied to the touch screen.

At block 23, a generation module generates one or more handwriting paths based on the coordinates of the recorded touch points, and generates one or more handwriting fonts according to the chosen thickness and the chosen color. The generation module further generates a first bitmap including the generated handwriting fonts. In at least one embodiment, each of the generated handwriting fonts is generated based on one or more non-matching paths.

At block 24, a determination module determines a minimum area of the generated handwriting fonts in the first bitmap and determines an area of a font in a text box of the electronic device.

At block 25, a calculation module calculates a compression ratio between the minimum area of the generated handwriting fonts in the first bitmap and the area of the font in the text box of the electronic device. In at least one embodiment, the calculation module calculates the compression ratio by using a formula. The formula can be denoted as “the compression ratio=(the minimum area of the generated handwriting fonts in the first bitmap)/(the area of the font in the text box of the electronic device).”

At block 26, an optimization module compresses the generated handwriting fonts in the first bitmap according to the compression ratio and generates a second bitmap including the compressed handwriting fonts. The second bitmap has the same size as the font in the text box. In at least one embodiment, the optimization module invokes a matrix function to compress the generated handwriting fonts in the first bitmap.

At block 27, a conversion module converts the second bitmap into a figure and output the figure in the text box of the electronic device. Thus, the method for outputting handwriting fonts can output handwriting fonts as written by a stylus or a finger of the user, but does not use standard fonts provided by the character input software to replace the handwriting fonts.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for outputting handwriting fonts using an electronic device, the method comprising:
choosing a thickness and a color for lines of handwriting fonts on a user interface on a touch screen of the electronic device;
recording coordinates of touch points in response to a handwriting operation on the touch screen;
generating one or more paths based on the coordinates of touch points, and generating one or more handwriting fonts based on the one or more paths according to the thickness and the color chosen;
generating a first bitmap comprising the one or more handwriting fonts;
determining a minimum area of the one or more handwriting fonts in the first bitmap and determining an area of a font in a text box of the electronic device;
calculating a compression ratio between the minimum area of the one or more handwriting fonts in the first bitmap and the area of the font in the text box of the electronic device;
compressing the one or more handwriting fonts according to the compression ratio into compressed handwriting fonts and generating a second bitmap comprising the compressed handwriting fonts, the second bitmap having the same size with the font in the text box; and
converting the second bitmap into a figure and outputting the figure in the text box of the electronic device.

2. The method according to claim 1, wherein each of the generated handwriting fonts is generated based on one or more non-matching paths.

3. The method according to claim 1, wherein the minimum area of the generated handwriting fonts in the first bitmap is determined according to coordinates of points of the generated handwriting fonts.

4. The method according to claim 1, wherein a formula of calculating the compression ratio is the compression ratio=(the minimum area of the generated handwriting fonts in the first bitmap)/(the area of the font in the text box of the electronic device).

5. The method according to claim 1, wherein a size of the first bitmap is the same as the touch screen.

6. An electronic device, comprising:
a touch screen;
at least one processor; and
a storage system that stores one or more programs, when executed by the at least one processor, cause the at least one processor to:
choose a thickness and a color for lines of handwriting fonts on a user interface on a touch screen of the electronic device;
record coordinates of touch points in response to a handwriting operation on the touch screen;
generate one or more paths based on the coordinates of touch points, and generating one or more handwriting fonts based on the one or more paths according to the thickness and the color chosen;
generate a first bitmap comprising the one or more handwriting fonts;
determine a minimum area of the one or more handwriting fonts in the first bitmap and determine an area of a font in a text box of the electronic device;
calculate a compression ratio between the minimum area of the one or more handwriting fonts in the first bitmap and the area of the font in the text box of the electronic device;
compress the one or more handwriting fonts according to the compression ratio into compressed handwriting fonts and generate a second bitmap comprising the compressed handwriting fonts, the second bitmap having the same size with the font in the text box; and
convert the second bitmap into a figure and output the figure in the text box of the electronic device.

7. The electronic device according to claim 6, wherein each of the generated handwriting fonts is generated based on one or more non-matching paths.

8. The electronic device according to claim 6, wherein the minimum area of the generated handwriting fonts in the first bitmap is determined according to coordinates of points of the generated handwriting fonts.

9. The electronic device according to claim 6, wherein a formula of calculating the compression ratio is the compression ratio=(the minimum area of the generated handwriting fonts in the first bitmap)/(the area of the font in the text box of the electronic device).

10. The electronic device according to claim 6, wherein a size of the first bitmap is the same as the touch screen.

11. A non-transitory storage medium having stored thereon instructions that, when executed by a processor of an electronic device, causes the processor to perform a method for handwriting output, the method comprising:
choosing a thickness and a color for lines of handwriting fonts on a user interface on a touch screen of the electronic device;
recording coordinates of touch points in response to a handwriting operation on the touch screen;
generating one or more paths based on the coordinates of touch points, and generating one or more handwriting fonts based on the one or more paths according to the thickness and the color chosen;
generating a first bitmap comprising the one or more handwriting fonts;
determining a minimum area of the one or more handwriting fonts in the first bitmap and determining an area of a font in a text box of the electronic device;
calculating a compression ratio between the minimum area of the one or more handwriting fonts in the first bitmap and the area of the font in the text box of the electronic device;
compressing the one or more handwriting fonts according to the compression ratio into compressed handwriting fonts and generating a second bitmap comprising the compressed handwriting fonts, the second bitmap having the same size with the font in the text box; and
converting the second bitmap into a figure and outputting the figure in the text box of the electronic device.

12. The non-transitory storage medium according to claim 11, wherein each of the generated handwriting fonts is generated based on one or more non-matching paths.

13. The non-transitory storage medium according to claim 11, wherein the minimum area of the generated handwriting fonts in the first bitmap is determined according to coordinates of points of the generated handwriting fonts.

14. The non-transitory storage medium according to claim 11, wherein a formula of calculating the compression ratio is the compression ratio=(the minimum area of the generated handwriting fonts in the first bitmap)/(the area of the font in the text box of the electronic device).

15. The non-transitory storage medium according to claim 11, wherein a size of the first bitmap is the same as the touch screen.
